(19) United States
(12) Patent Application Publication
(10) Pub. No.: US 2006/0091177 A1
(43) Pub. Date: May 4, 2006

(54) Operational lock and depth adjustment for fastening tool

(76) Inventors: Michael F. Cannaliato, Bel Air, MD (US); Terry L. Turner, Westminster, MD (US); Luis A. Guanzon, Joppa, MD (US); Richard J. Heavel, Hanover, PA (US); Thomas Wheeler, Pomona, CA (US)

Correspondence Address: HARNESS, DICKEY & PIERCE, P.L.C., P.O. BOX 828, BLOOMFIELD HILLS, MI, 48303, US

(21) Appl. No.: 10/978,868

(22) Filed: Oct. 29, 2004

(51) Int. Cl. B25C 1/00

(52) U.S. Cl. 227/8; 227/142; 227/131

(57) ABSTRACT

A fastening tool including a contact trip mechanism having a trigger block. The contact trip mechanism is moveable to a retracted position. The fastening tool also includes a slider member connected to the trigger block and a link member adjustably coupled to the slider member. The fastening tool further includes a lockout pin movable between a first position and a second position. The lockout pin in the first position decouples the slider member and the link member and holds the trigger block in a blocked position.

### FIELD OF THE INVENTION

The present invention relates to a cordless fastening tool and more specifically to a depth adjustment mechanism and an operational lock.

### BACKGROUND OF THE INVENTION

Traditional fastening tools can employ pneumatic actuation to drive a fastener into a work-piece. In these tools, air pressure from a pneumatic system can be utilized to both drive the fastener into the work-piece and to reset the tool after driving the fastener. It will be appreciated that in the pneumatic system a hose and a compressor are required to accompany the tool. To that end, a combination of the hose, the tool and the compressor provides for a large, heavy and bulky package that is relatively inconvenient and cumbersome to transport.

One alternative to a tool that requires a pneumatic system are tools that employ combustion systems for generating power to drive a fastener into a work-piece. These tools typically hold a combustible propellant and have a battery that is employed to produce a spark for igniting the combustible propellant. Expanding combustion gases are used to drive the fastener. Additional propellant canisters, therefore, must be carried to ensure continued use of the fastening tool. Moreover, the combustion system can exhaust combustion gases in close proximity to the user.

These fastening tools often times employ a relatively complicated depth adjustment scheme that is integrated into a contact trip. These depth adjustment schemes can employ thumb-wheels and threaded rods to adjust the depth at which the fastening tool drives the fastener into the work-piece. While such depth adjustment schemes work well for their intended purpose, they tend to be relatively more expensive, relatively slow to adjust and provide a more finite range of depth adjustment than is typically needed for some applications, particularly consumer-grade fastening tools. Accordingly, there is a need in the art for an improved depth adjustment scheme.

### SUMMARY OF THE INVENTION

A fastening tool including a contact trip mechanism having a trigger block. The contact trip mechanism is moveable to a retracted position. The fastening tool also includes a slider member connected to the trigger block and a link member adjustably coupled to the slider member. The fastening tool further includes a lockout pin movable between a first position and a second position. The lockout pin in the first position decouples the slider member and the link member and holds the trigger block in a blocked position.

Further areas of applicability of the present invention will become apparent from the detailed description provided hereinafter. It should be understood that the detailed description and specific examples, while indicating the various embodiment of the invention, are intended for purposes of illustration only and are not intended to limit the scope of the invention.

### BRIEF DESCRIPTION OF THE DRAWINGS

The present invention will become more fully understood from the detailed description, the appended claims and the accompanying drawings, wherein:

FIG. 1 is a perspective view of an exemplary cordless fastening tool constructed in accordance with the teachings of the present invention showing an exemplary fastener and an exemplary work-piece;

FIG. 2 is similar to FIG. 1 and shows a transmission, a driver mechanism and a control module constructed in accordance with the teaching of the present invention;

FIG. 3 is a partial perspective view of the fastening tool of FIG. 1 and shows the transmission and the driver mechanism including a crank link track and a crank link return-spring;

FIG. 4 is a partial perspective view of the fastening tool of FIG. 1 and shows the driver mechanism and the transmission including a flywheel, a cam gear, a first drive gear and a second drive gear;

FIG. 5 is a partial front view of the transmission showing the flywheel and the cam gear prior to engagement with a clutch pin;

FIG. 6 is similar to FIG. 4 but shows the transmission prior to engagement with the driver mechanism;

FIG. 7 is similar to FIG. 5 but shows a ramp on the cam gear in contact with the clutch pin;

FIG. 8 is similar to FIG. 6 but shows the driver mechanism in bottom position;

FIG. 9 is an exploded assembly view of a contact trip mechanism including a depth adjustment mechanism constructed in accordance with the teachings of the present invention;

FIG. 10 is a front view of the contact trip mechanism in a retracted position;

FIG. 11 is a front view of the contact trip mechanism of FIG. 10 showing the contact trip mechanism in an extended position;

FIG. 12a is a partial front view of the contact trip mechanism of FIG. 10 showing the slider member disengaged from the link member, wherein the slider member is in a condition where it has pivoted away from the link member to effect the disengagement of the slider member from the link member;

FIG. 12b is a view that is similar to FIG. 12a but which shows an alternately constructed contact trip mechanism wherein the slider member is in a condition where it has translated away from the link member to effect the disengagement of the slider member from the link member;

FIG. 13 is similar to FIG. 12 and shows the link member in a lower position to effectively elongate the contact trip mechanism;

FIG. 14 is similar to FIG. 13 and shows the slider member engaged with the link member;

FIG. 15 is a partial top view of a lockout catch, a trigger switch and an actuation member constructed in accordance with the teachings of the present invention;

FIG. 16 is similar to FIG. 15 but shows lockout catch preventing the actuation member from contacting the trigger switch;

FIG. 17 is similar to FIG. 15 and shows the lockout catch in an operational position; and

FIG. 18 is similar to FIG. 17 and shows a trigger block in an unblocked position and the actuation member contacting the trigger switch.

### DETAILED DESCRIPTION OF THE VARIOUS EMBODIMENTS

The following description of the various embodiments is merely exemplary in nature and is in no way intended to limit the invention, its application or uses.

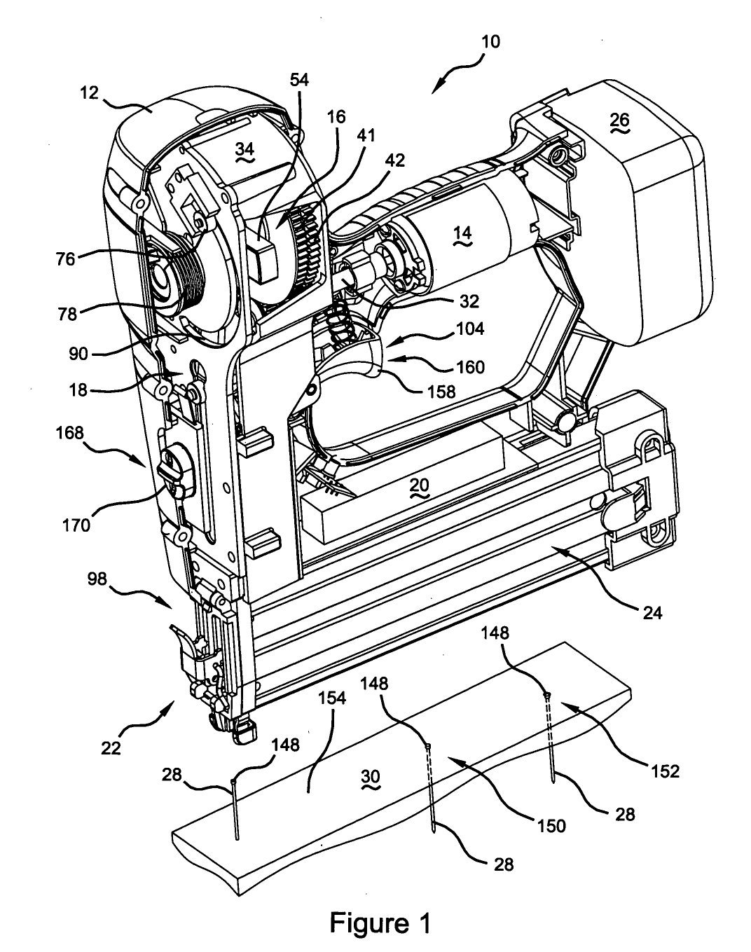

With reference to FIG. 1, an exemplary fastening tool constructed in accordance with the teachings of the present invention is shown and generally indicated by reference numeral 10. The fastening tool 10 can include an exterior housing 12, which can house a motor 14, a transmission 16, a driver mechanism 18 and a control module 20. The fastening tool 10 can also include a nosepiece 22 and a fastener magazine 24 and a battery 26. The fastener magazine 24 can be coupled to the driver mechanism 18, while the battery 26 can be coupled to the exterior housing 12. The motor 14 can drive the transmission 16, which in turn can actuate the driver mechanism 18. Actuation of the driver mechanism 18 can drive fasteners 28, which are sequentially fed from the fastener magazine 24 into the nosepiece 22, into a work-piece 30. The fasteners 28 could be nails, staples, brads, clips or any such suitable fastener that could be driven into the work-piece 30.

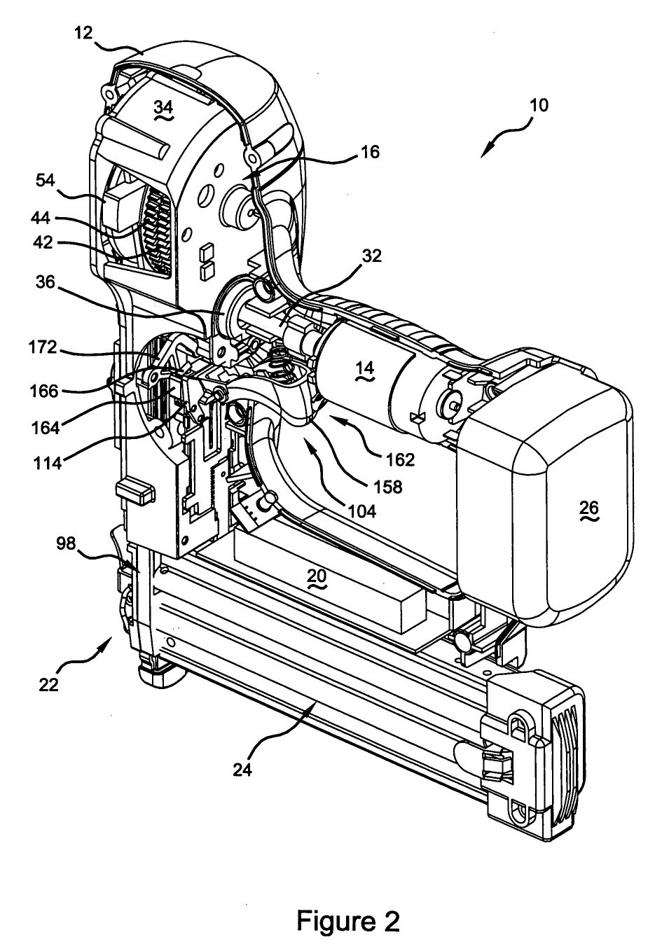

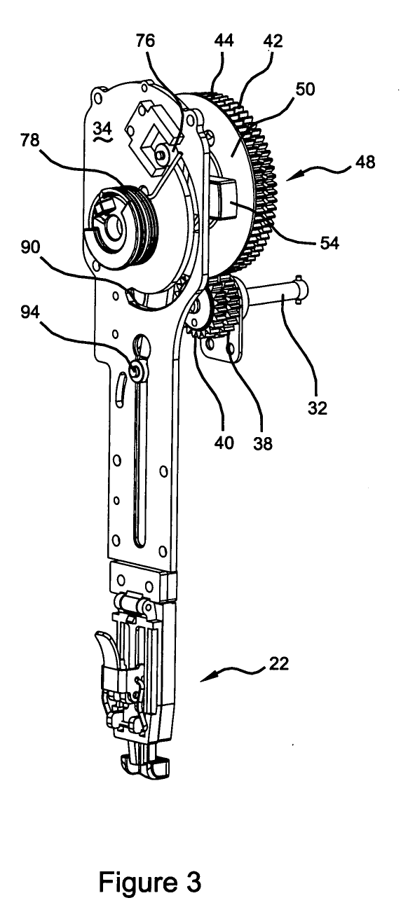

With reference to FIG. 2, a driveshaft 32 can connect an input (not specifically shown) of the transmission 16 to an output (not specifically shown) of the motor 14. A transmission housing 34 can encase the transmission 16, a portion of a driveshaft 32 and various components of the transmission 16. A driveshaft bearing 36 can be employed to journally support the driveshaft 32 in the transmission housing 34. With reference to FIGS. 2 and 3, the transmission 16 can include a first drive gear 38 and a second drive gear 40 that can be coupled for rotation with the driveshaft 32 within the transmission housing 34. The first drive gear 38 can be closer to the motor 14 relative to the second drive gear 40. It will be appreciated that the driveshaft 32, the first drive gear 38 and the second drive gear 40 can rotate at the same rotational speed.

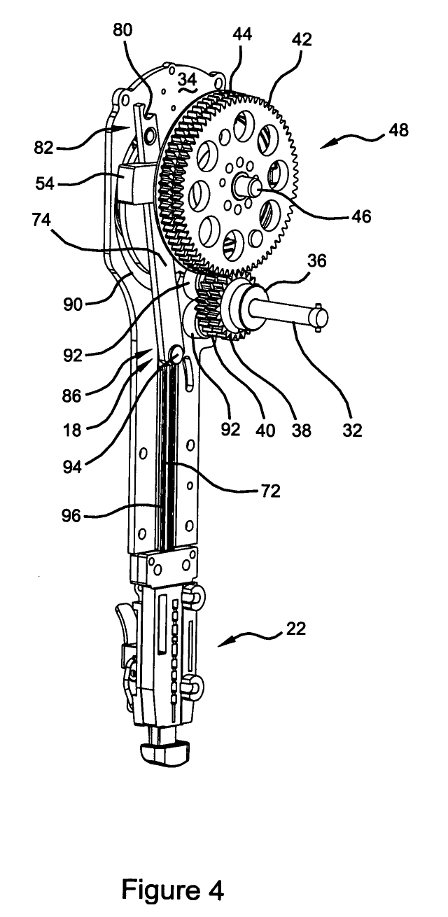

With reference to FIGS. 3 and 4, the transmission 16 (FIG. 2) can also include a flywheel 42 and a cam gear 44 that can be mounted for rotation on a transmission shaft 46. The first drive gear 38 can meshingly engage and drive the flywheel 42 while the second drive gear 40 can meshingly engage and drive the cam gear 44. The flywheel 42, the cam gear 44, the first drive gear 38 and the second drive gear 40 can form a transmission gear set 48. To that end, each gear of the transmission gear set 48 can be configured (e.g., by pitch diameter and/or by number of teeth) so that the flywheel 42 and the cam gear 44 rotate at different rotational speeds. The flywheel 42, for example, can rotate in response to rotation of the driveshaft 32 at a faster rotational velocity than the cam gear 44.

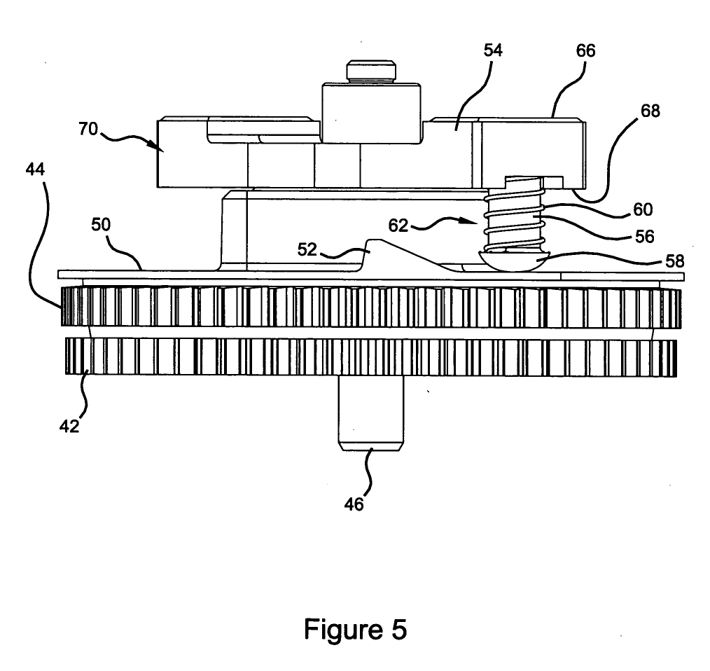

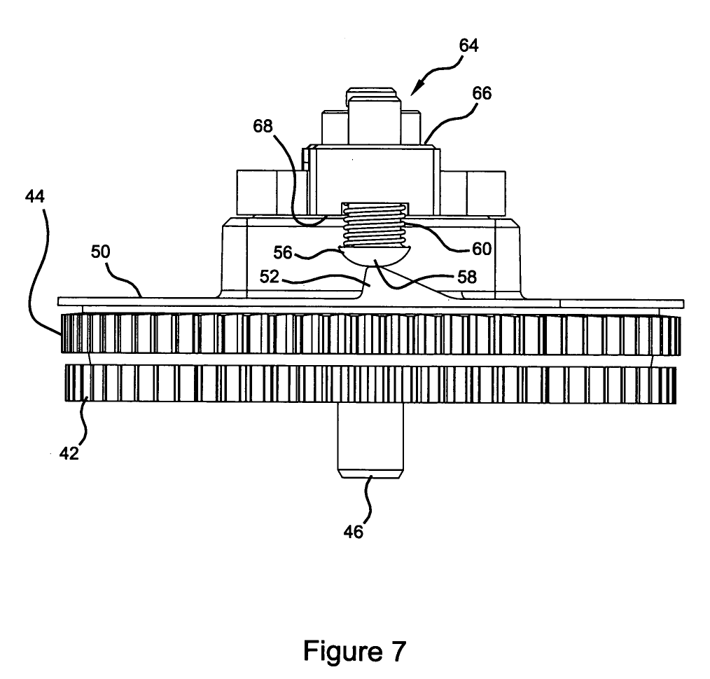

With reference to FIG. 5 through FIG. 8, the cam gear 44 can include a cover 50 defining a ramp 52. The cover 50 can fixedly connect to the cam gear 44 opposite the flywheel 42. The flywheel 42 can include a clutch arm 54 that can rotate with the remainder of the flywheel 42. The clutch arm 54 can be disposed on a side of the ramp 52 opposite the cam gear 44. The ramp 52 can be configured to engage a clutch pin 56 that is carried by the clutch arm 54, as shown in FIG. 7. For example, rotation of the cam gear 44 at a rotational velocity that is less than that of the flywheel 42 can cause a head 58 of the clutch pin 56 to advance toward or approach the ramp 52, as is illustrated in FIGS. 5 and 7. A clutch pin spring 60 can bias the clutch pin 56 into a retracted or a seated position 62, which is shown in FIG. 5. Contact between the ramp 52 and the clutch pin 56 can cause the clutch pin 56 to travel up the ramp 52 and push the clutch pin 56 outwardly from the clutch arm 54 from the seated position 62 into an extended position 64, as shown in FIG. 7.

It will be appreciated that when the clutch pin 56 is in the extended position 64, the clutch pin 56 can extend above a face 66 of the clutch arm 54 in a direction opposite the cover 50. In the seated position 62, the clutch pin 56 can extend below an opposite clutch arm face 68, which can be adjacent to the cover 50. It will also be appreciated that the clutch arm 54 can be counter-balanced such that the clutch pin 56 is radially spaced apart from a center of the transmission shaft 46. The opposite side of the clutch arm 54, which can counter-balance the clutch pin 56 with a suitable weight 70, is distal from the clutch pin 56.

When the clutch pin 56 contacts the ramp 52, the ramp 52 pushes the clutch pin 56 into the extended position 64, as shown in FIG. 7. In the extended position 64, the clutch pin 56 engages the driver mechanism 18. It will be appreciated that the extended position 64 can coincide with placement of the clutch pin 56 along any part of the ramp 52 that permits the clutch pin 56 to extend from the clutch arm 54 by a distance that is sufficient to engage the driver mechanism 18.

The driver mechanism 18 includes a driver blade 72 that connects to a crank link 74. The crank link 74 includes a crank link cam 76 (FIG. 3). The driver mechanism 18 also includes a crank link return-spring 78 (FIG. 3) that can connect to the crank link cam 76. The clutch pin 56 can engage the crank link 74 at a pin catch 80 (FIG. 4) and can drive the crank link 74 from a first position 82 to a second position 84. The motion of the crank link 74, in turn, moves the driver blade 72 from a top position 86 to a bottom position 88. As the fastener 28 in the nosepiece 22 is located in the driver blade's 72 path of travel, the driver blade 72 can insert (i.e., drive) the fastener 28 into the work-piece 30 (FIG. 1) as it travels to the bottom position 88.

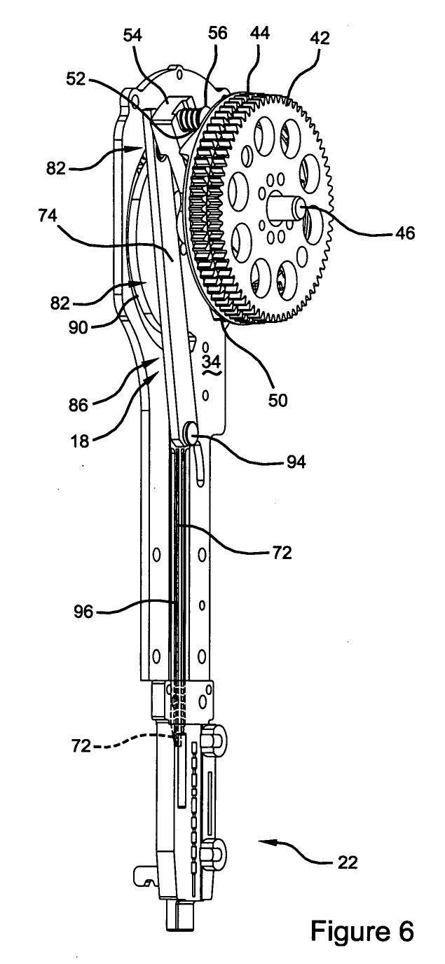

When the clutch pin 56 rotates beyond the ramp 52, the clutch pin spring 60 pushes the clutch pin 56 back into the seated position 62. When the clutch pin 56 is no longer engaging the crank link 74, the crank link return-spring 78 (FIG. 3) can return the crank link 74 to the first position 82, as shown in FIG. 6. The crank link cam 76 can be disposed in a link track 90 on the transmission housing 34. The crank link return-spring 78 can urge (bias) the crank link cam 76 along the link track 90 toward the first position 82. When the crank link 74 returns to the first position 82, the fastening tool 10 has completed a driver sequence.

It will be appreciated that the driver sequence can include the clutch pin 56 engaging the pin catch 80 and driving the crank link 74; the driver blade 72 translating from the first and top positions 82, 86 to the second and bottom positions 84, 88; the clutch pin 56 disengaging the pin catch 80; and the crank link return-spring 78 urging the crank link cam 76 upwardly in the link track 90 to cause the crank link 74 and the driver blade 72 to return to the first and top positions 82, 86, which can complete the driver sequence.

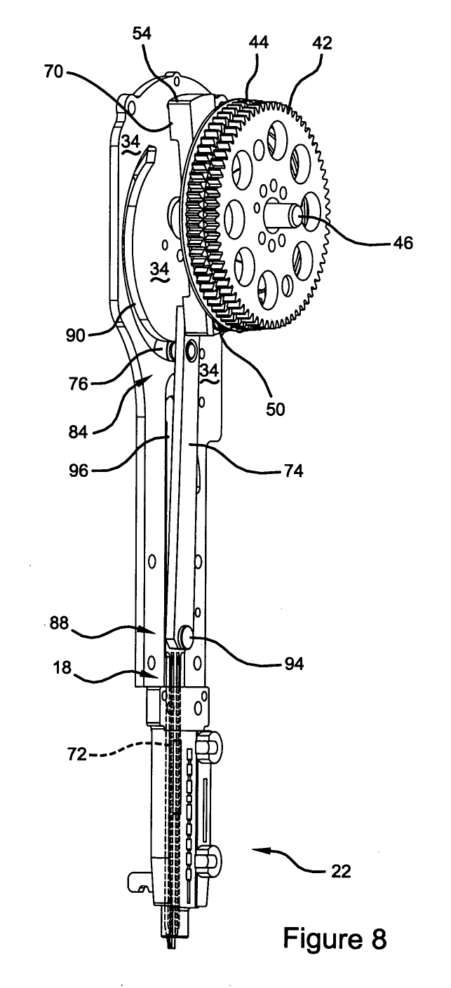

With reference to FIGS. 4 and 8, it will be appreciated that the crank link 74 can be configured such that travel beyond the second position 84 can be limited by, for example, one or more resilient bumpers 92. The clutch pin 56 (FIG. 5), therefore, can disengage from the crank link 74 at the bottom position 88. It will also be appreciated that a link joint 94 can pivotally connect the crank link 74 and the driver blade 72. The link joint 94 can allow the crank link 74 to travel in an approximately circular path, while the driver blade 72 travels in a vertical path (i.e., up and down). Moreover, a blade channel 96 can be employed to confine the driver blade 72 for movement along a desired axis to ensure travel in an up and down direction.

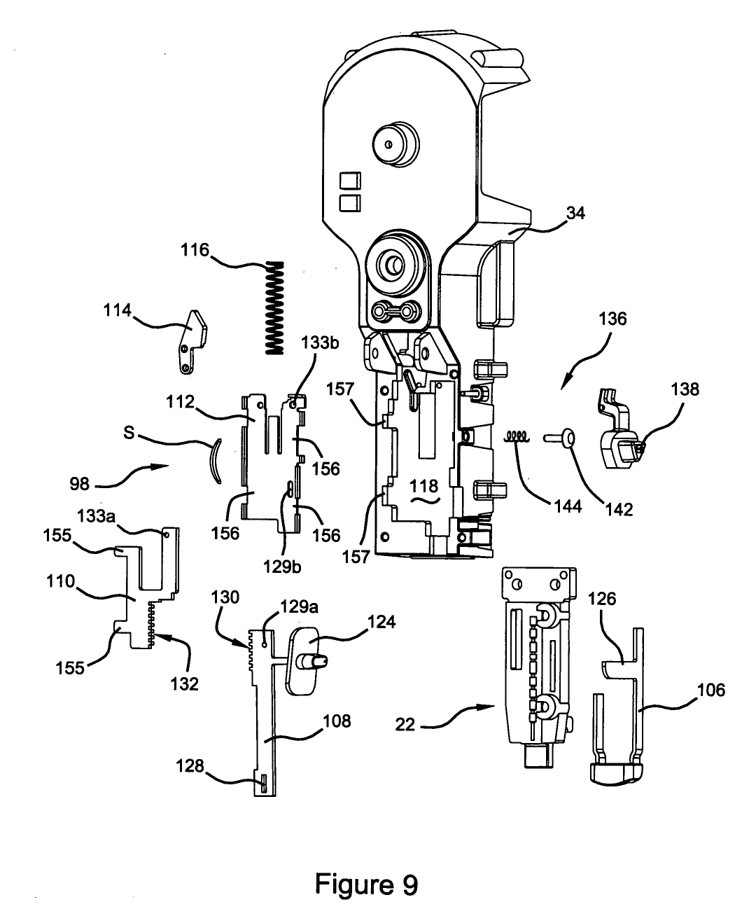

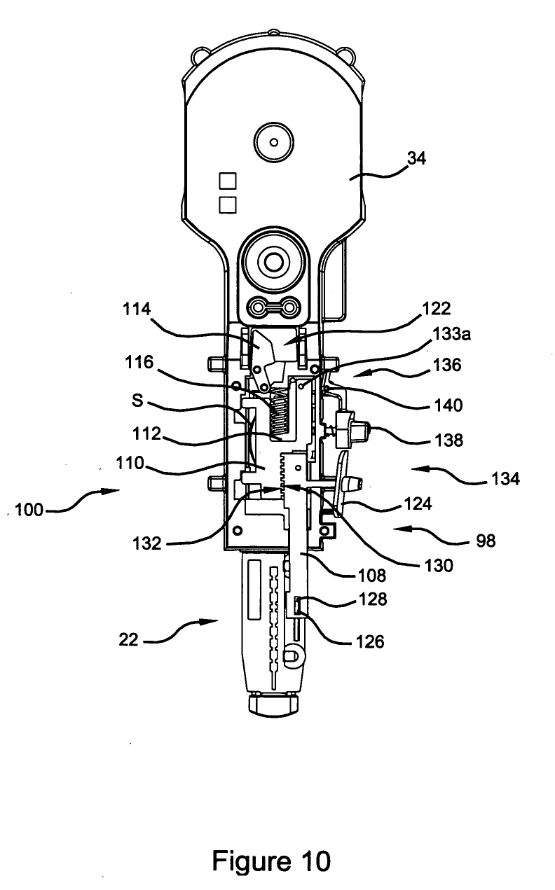

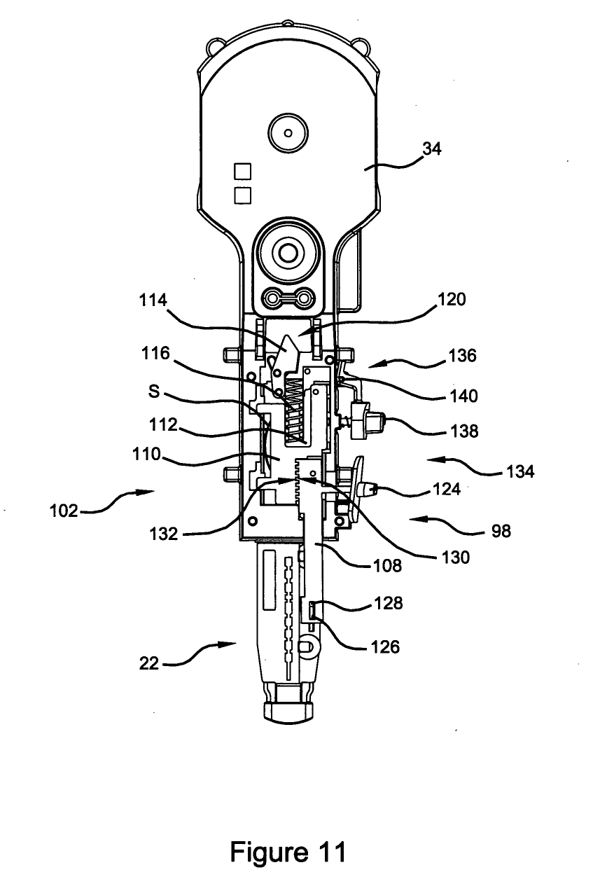

With reference to FIGS. 9-11, the nosepiece 22 can include a contact trip mechanism 98 that is movable between a retracted position 100, which is illustrated in FIG. 10, and an extended position 102, which is illustrated in FIG. 11. The contact trip mechanism 98 can be configured to prevent the fastening tool 10 from executing the driver sequence unless the contact trip mechanism 98 is in the retracted position 100 (FIG. 10) (e.g., pressed against the work-piece 30).

The contact trip mechanism 98 can include a multi-component mechanical linkage that can connect the nosepiece 22 to a trigger assembly 104 (FIG. 2). The contact trip mechanism 98 can include a contact member 106 that connects to a nosepiece 22. The contact member 106 can connect to a link member 108. The link member 108 can connect to a slider member 110. The slider member 110 can connect to a carrier member 112. The carrier member 112 can connect to a trigger block 114. The carrier member 112 can also connect to a contact trip spring 116. The carrier member 112 and the contact trip spring 116 can connect to a carrier depression 118 formed in the transmission housing 34. By way of example, when the contact member 106 is pushed against the work-piece 30, the contact member 106 moves up (i.e., toward the flywheel 42). When the contact member 106 moves up, the contact trip mechanism 98 can move into the retracted position 100. In the retracted position 100, the trigger block 114 can pivot from a blocked position 120 to an unblocked position 122.

More specifically, the contact member 106 can include an adjusting lever 124 and a nose-link portion 126 that can extend approximately orthogonally to a remainder of the contact member 106. The nose-link portion 126 can fit into a nose-link aperture 128 formed on the link member 108. The link member 108 can further includes a pin 129a that can extend through the link member 108 and into a slot 129b formed in the carrier member 112. The link member 108 can also include a plurality of teeth 130 that are distal from the nose-link aperture 128. The plurality of teeth 130 on the link member 108 can engage with a plurality of teeth 132 on the slider member 110. A slider pin 133a can be employed to pivotally couple the slider member 110 to the carrier member 112. In the example provided, the slider pin 133a is fixedly coupled to the slider member 110 and rotatably disposed in a slider pin aperture 133b in the carrier member 112. The plurality of teeth 130 formed on the link member 108 can be disposed within the carrier depression 118 formed on the transmission housing 34. A more detailed discussion of the contact trip mechanism 98 is disclosed in commonly assigned U.S. patent application entitled Cordless Fastening Tool Nosepiece with Integrated Contact Trip and Magazine Feed, filed herewith on ______, Ser. No. ______, which is incorporated by reference as if fully set forth herein.

In FIGS. 9 and 10, a depth adjustment assembly 134 can be employed to control the depth at which the fastener 28 is driven into the work-piece 30 (e.g., counter-sink or flush). The depth adjustment assembly 134 can include two sets of mating teeth that can be employed to set and selectively change the effective length of the contact trip mechanism 98 as desired. In the particular example provided, the plurality of teeth 130 of the link member 108 can be selectively engaged to the plurality of teeth 132 of the slider member 110. The pluralities of teeth 130, 132 can be disengaged and then can be reengaged at a different location to change the effective length of the contact trip mechanism 98. By changing the effective length of the contact trip mechanism 98, the user can control the depth that the fastening tool 10 drives the fastener 28 into the work-piece 30.

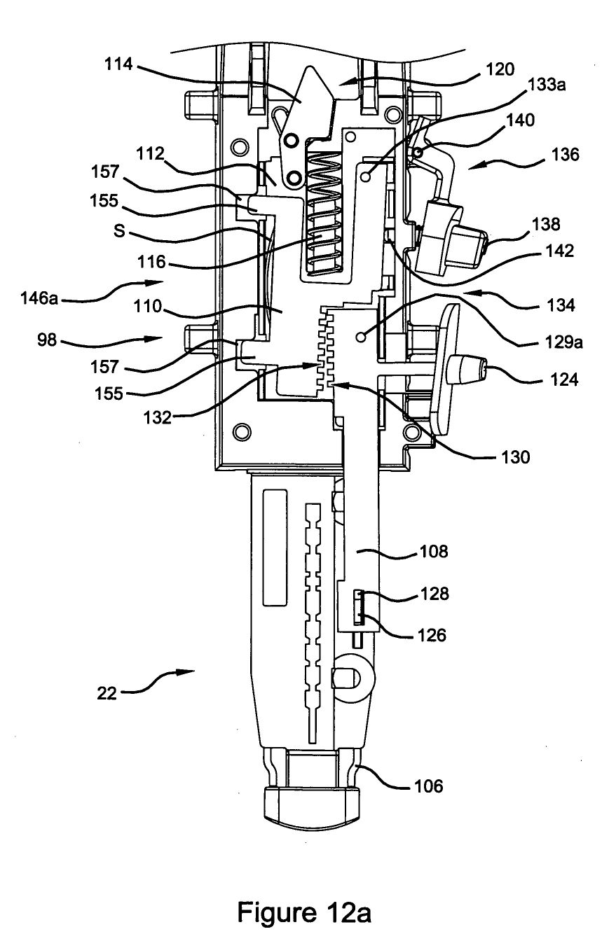

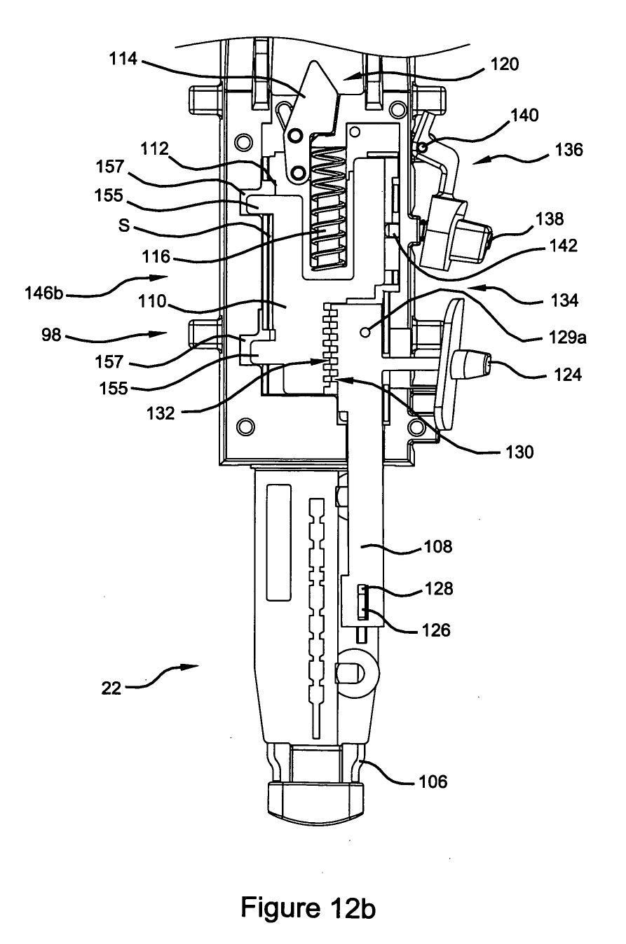

The depth adjustment assembly 134 can also include a depth adjustment actuator mechanism 136. The actuator mechanism 136 can include an actuator button 138 that can be hinged via an assembly pin 140 to the transmission housing 34. An actuator pin 142 can be disposed in an actuator spring 144 and can be connected to the actuator button 138. As shown in FIGS. 12a and 12b, the user can press the actuator button 138 to push the actuator pin 142 against the bias of the actuator spring 144 and into contact with the slider member 110. Sufficient movement of the slider member 110 away from the link member 108 can disengage the slider member 110 from the link member 108. It will be appreciated that the pin 129a on the link member 108, which is disposed in the groove 129b on the carrier member 112, can restrain the link member 108 and thereby prevent the link member 108 from moving with the slider member 110.

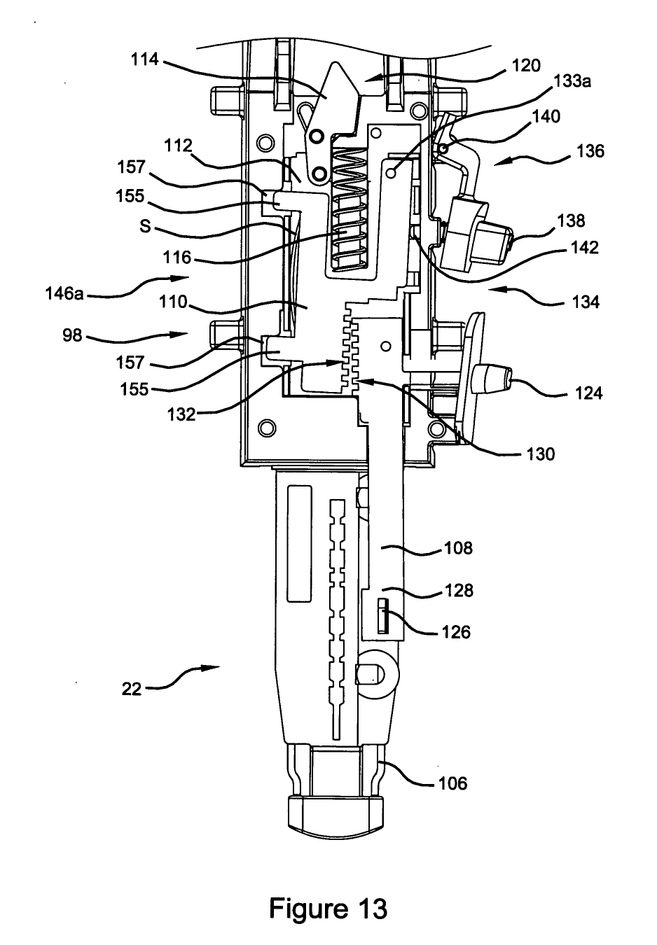

As shown in FIG. 12a, the slider member 110 can pivot away from the link member 108 in a clockwise fashion upon the slider pin 133a, as generally indicated by reference numeral 146a. As such, the plurality of teeth 132 on the slider member 110 can disengage from the plurality of teeth 130 on the link member 108. With reference to FIG. 13, the link member 108 can be disengaged from the slider member 110 and the user can move the adjusting lever 124 of the link member 108 up and/or down (as illustrated in FIG. 13) to decrease and/or increase, respectively, the effective length of the contact trip mechanism 98. With reference to FIG. 12b, the depth adjustment assembly 134 may be alternatively configured so as to omit the slider pin 133a (FIG. 12a). In that configuration, the slider member 110 can translate away from the link member 108 in a horizontal fashion (i.e., right to left in FIG. 12b), as generally indicated by reference numeral 146b.

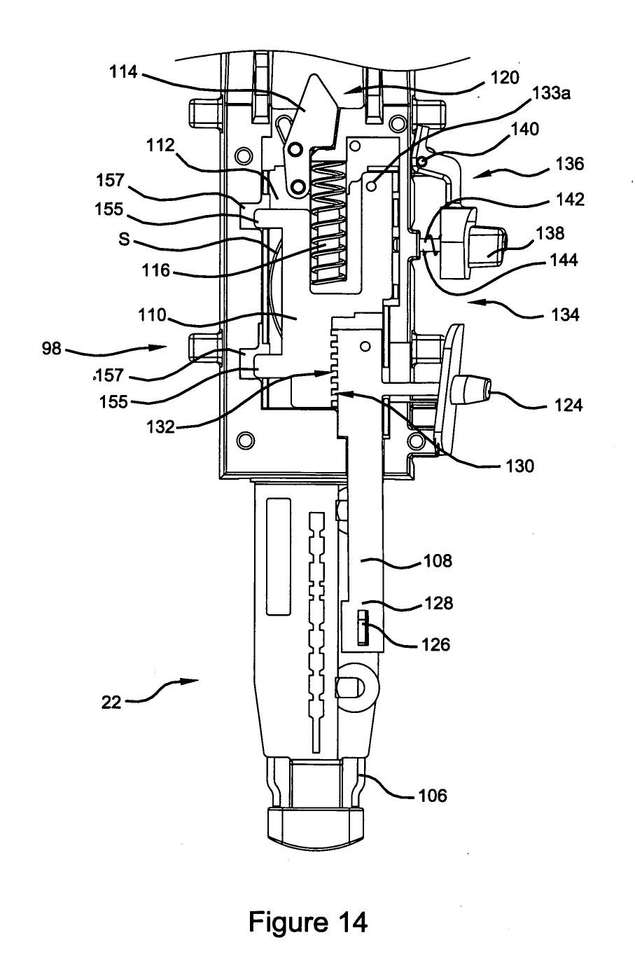

With reference to FIGS. 1, 12a, 13 and 14, it will be appreciated that increasing or decreasing the length of the contact trip mechanism 98 can change the depth at which the fastener 28 is driven into the work-piece 30. More specifically, the fastening tool 10 can be configured to drive the fastener 28 into the work-piece 30 such that a head 148 (FIG. 1) of the fastener, for example, will sit flush with the work-piece 30, which is generally indicated by reference numeral 150. The depth adjustment assembly 134 can also be adjusted such that the head 148 of the fastener 28 can be sunk into (i.e., below the surface of) the work-piece 30, which is generally indicated by reference numeral 152 (FIG. 1). It will be appreciated that when the head 148 of the fastener 28 is counter-sunk the head 148 is disposed below a surface 154 of the work-piece 30.

With reference to FIGS. 12a and 13, when the actuator button 138 presses the actuator pin 142 against the slider member 110, the actuator pin 142 can also be employed to restrain movement of the carrier member 112. For example, the actuator pin 142 can push the slider member 110 such that protrusions 155 formed on the slider member 110 can be inserted through recesses 156 (FIG. 9) on the carrier member 112 and into slots 157 that can be formed into the transmission housing 34 and which intersect the carrier depression 118. When the protrusions 155 are pushed into the slots 157, the contact trip mechanism 98 is held in the extended position 102 (FIG. 11) and also prevented from moving into the retracted position 100 (FIG. 10). It will be appreciated that when the contact trip mechanism 98 is held in the extended position 102, the fastening tool 10 will not be able to execute the driver sequence. It will also be appreciated that the contact trip mechanism 98 illustrated and described herein is held in the extended position 102 while the user adjusts the effective length of the contact trip mechanism 98.

Once the user has selected a suitable position for the link member 108 (i.e., selecting a suitable depth for the fastener 28) the user can release the actuator button 138. Release of the actuator button 138, in turn, allows the actuator spring 144 to push the actuator pin 142 away from the slider member 110. A spring S (FIG. 9), such as a leaf spring, may be employed to urge the slider member 110 toward the link member 108 so that the plurality of teeth 130 on the slider member 110 can reengage with the plurality of teeth 130 on the link member 108. By decoupling two members 110, 112, adjusting the effective length of the contact trip mechanism 98 and coupling the two members 110, 112, the user can adjust the depth at which the fastener 28 is driven into the work-piece 30.

With reference to FIGS. 1 and 2, the trigger assembly 104 can mount to the transmission housing 34 and extend through the exterior housing 12. The trigger assembly 104 can include a trigger 158 that can be biased into an extended position 160 (FIG. 1). The user can move (i.e., pivot and/or translate) the trigger 158 into an activated position 162 (FIG. 2). When the trigger 158 is in the activated position 162 and the trigger block 114 is in the unblocked position 122, the trigger 158 can activate a trigger switch 164. More specifically, a trigger actuation member 166 can be employed to couple the trigger 158 to the trigger switch 164 and can cause the trigger switch 164 to generate a trigger signal (not shown). When the trigger 158 activates or closes the trigger switch 164, the fastening tool 10 can execute the driver sequence. Electronic control of the fastening tool 10 and the communication to and/or from the control module 20 (e.g., transmission and receipt of the trigger signal) is outside the scope of the present disclosure but is disclosed in greater detail in commonly assigned U.S. patent application entitled Electronic Control of a Cordless Fastening Tool, filed herewith on ______, Ser. No ______ , which is hereby incorporated by reference as if fully set forth herein.

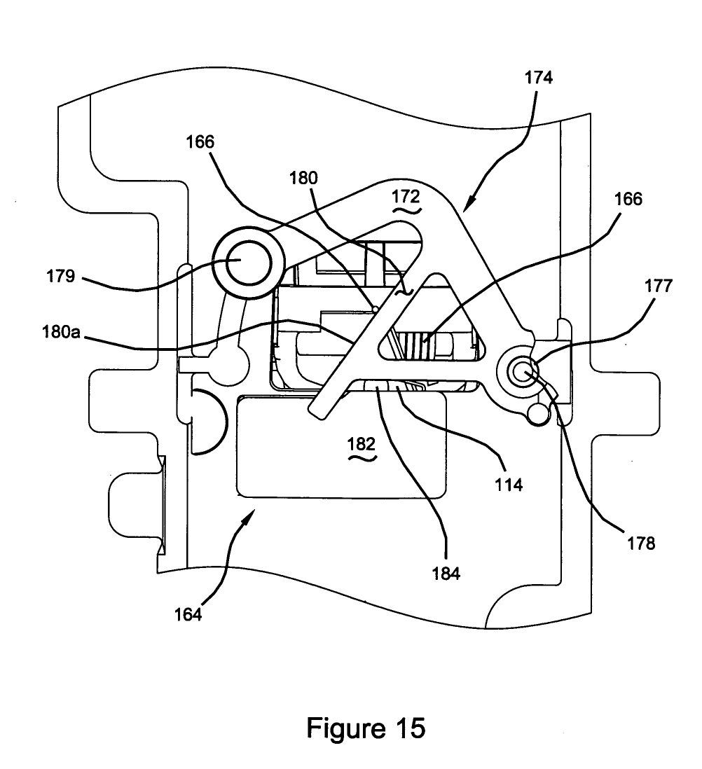

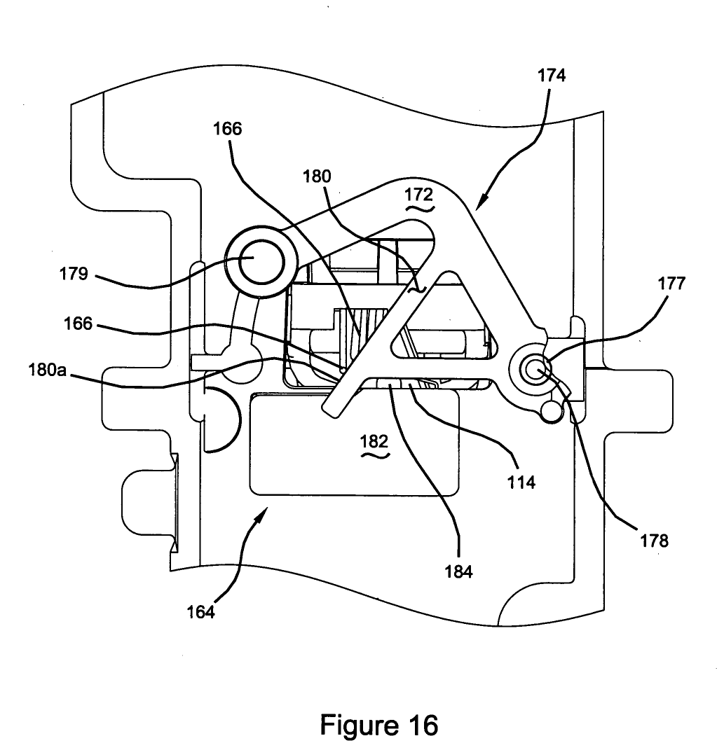

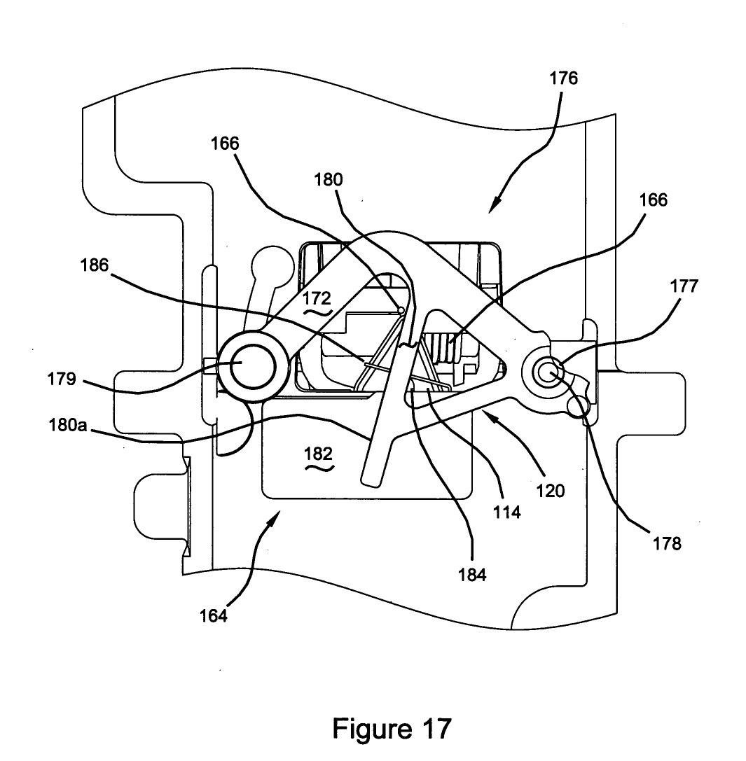

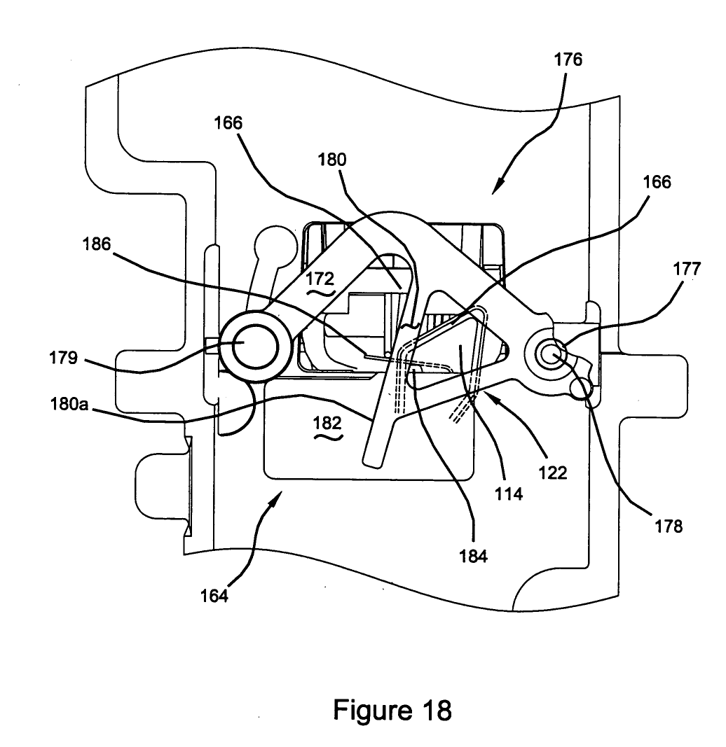

With reference to FIGS. 1 and 15-18, the fastening tool 10 can have an operational lockout mechanism 168 that can also inhibit the fastening tool 10 from executing the driver sequence. The operational lockout mechanism 168 can include a lockout switch 170 (FIG. 1) that can be connected to an actuator catch 172. The lockout switch 170 can be mounted to the exterior housing 12 and can be coupled to the lockout catch 172. The lockout switch 170 and the lockout catch 172 can move between a lockout position 174, which is illustrated in FIGS. 15 and 16, and an operational position 176, which is illustrated in FIGS. 17 and 18. The actuator catch 172 can include an aperture 177 through which a catch pin 178 formed in the transmission housing 34 is disposed to pivotally connect to the lockout catch 172 to the transmission housing 34. The actuator catch 172 can include a second catch pin 179 that can couple the actuator catch 172 with the actuator switch 170.

With reference to FIGS. 15 and 16, when the lockout switch 170 (FIG. 1) is in the lockout position 174, the lockout catch 172 can hold the trigger actuation member 166 away from the trigger switch 164. More specifically, when the trigger actuation member 166 is urged toward the trigger switch 164, a portion of the lockout catch 172, such as an arm 180 lockout, can be configured to urge the trigger actuation member 166 away from the trigger switch 164, as shown in FIG. 16. In the example provided, a sloping surface 180a of the arm 180 deflects the trigger actuation member 166 away from a trigger switch actuator 184 as the trigger 158 (FIG. 1) urges the trigger actuation member 166 toward the trigger switch 164. Because movement of the trigger switch actuator 184 is necessary to actuate the trigger switch 164 and because the sloping surface 180a of the arm 180 inhibits contact between the trigger actuation member 166 and the trigger switch actuator 184, the trigger switch 164 cannot be actuated when the lockout switch 170 (FIG. 1) is in the lockout position 174.

With reference to FIGS. 17 and 18, when the lockout switch 170 (FIG. 1) is in the operational position 176, the actuator catch 172 does not inhibit movement of the trigger actuator member 166. In the example provided, when the trigger actuation member 166 is urged toward the trigger switch 164, the arm 180 can be configured so as not to block the trigger actuation member 166 when it is urged by the trigger 158 (FIG. 1) toward the trigger switch actuator 184. As shown in FIG. 17, the trigger block 114 of the contact trip mechanism 98 (FIG. 9) can additionally block the trigger actuation member 166 from contacting the trigger switch 164 in the example provided, as when the contact trip mechanism 98 (FIG. 9) is in the extended position.

In FIG. 18, the operation lockout mechanism 168 (FIG. 1) is in the operational position 176, and trigger block 114 is in the unblocked position 122. In this arrangement, trigger 158 (FIG. 1) may be employed to move the trigger actuation member 166 into contact with the trigger switch actuator 184 to actuate the trigger switch 164 and execute the driver sequence. It will be appreciated that when the lockout switch 170 (FIG. 1) is in the lockout position 174 (FIG. 15), the trigger actuation member 166 is prevented from contacting the trigger switch actuator 184 and as such, the fastening tool cannot be activated even when the trigger 158 (FIG. 1) is positioned in the activated position 162 (FIG. 2) and the contact trip mechanism 98 is moved to the retracted position 100 (FIG. 10). To that end, the lockout switch 170 (FIG. 1) can completely prevent operation of the fastening tool 10 (FIG. 1) when placed in the lockout position 174 (FIG. 15).

The trigger switch 164 can be any suitable type of switch including, but not limited to, a micro switch. The trigger switch 164 can include a trigger switch body 182 and the trigger switch actuator 184. It can be appreciated that the trigger actuation member 166 can contact the trigger switch body 182 and that this contact does not operate to activate the trigger switch 164. Rather, actuation of the trigger switch 164 is effected through contact between the trigger actuation member 166 and the trigger switch actuator 184 and/or an actuator lever 186 that can pivot to make contact with the trigger switch actuator. While the particular trigger switch 164 illustrated utilizes a translating member for the trigger switch actuator 184, those of ordinary skill in the art will appreciate that other switch configurations, including those that use a pivoting lever to push a translating member, may be readily substituted for that which is illustrated herein. By way of the above example, the trigger block 114 can deflect the trigger actuation member 166 from the trigger switch actuator 184 when the trigger block 114 is in the blocked position 120 (FIG. 17), but the trigger actuation member 166 may still contact the trigger switch body 182.

Those skilled in the art can now appreciate from the foregoing description that the broad teachings of the present invention can be implemented in a variety of forms. Therefore, while this invention has been described in connection with particular examples thereof, the true scope of the invention should not be so limited because other modifications will become apparent to the skilled practitioner upon a study of the drawings, the specification and the following claims.
What is claimed is:

1. A fastening tool for inserting a fastener into a work-piece, the fastening tool comprising:
a contact trip mechanism having a trigger block, said contact trip mechanism moveable between an extended position and a retracted position:
a slider member connected to said trigger block;
a link member adjustably coupled to said slider member; and
an actuator assembly including an actuator pin movable between a first position and a second position, said pin in said first position decoupling said slider member and said link member and holding said trigger block in a blocked position.

2. The fastening tool of claim 1 wherein said trigger block is in an unblocked position when said contact trip mechanism is in said retracted position.

3. The fastening tool of claim 1 wherein said trigger block is in a blocked position when said contact trip mechanism is in said extended position.

4. The fastening tool of claim 1 further comprising a carrier member that connects said trigger block to said slider member.

5. The fastening tool of claim 4 further comprising a pin formed on said slider member coupled to an aperture formed on said carrier member, said slider member pivots relative to said link member when said actuator pin decouples said link member and said slider member.

6. The fastening tool of claim 1 further comprising an adjusting lever connected to said link member wherein said adjusting lever can move said link member to a plurality of positions relative to said slider member.

7. The fastening tool of claim 1 wherein said link member is coupled to said slider member at a lower position relative to said slider member to effectively elongate said contact trip mechanism.

8. The fastening tool of claim 6, wherein said effective elongation of said contact trip mechanism adjusts a depth at which the fastening tool inserts the fastener.

9. A fastening tool having an exterior housing, the fastening tool comprising:
a nosepiece;
a contact trip mechanism including a contact member coupled to said nosepiece, a link member associated with said nosepiece, and a slider member associated with a trigger switch, said link member adjustably coupled to said slider member; and
an actuator mechanism connected to the exterior housing, said actuator mechanism being selectively operable to both uncouple said link member and said slider member and to permit a length of the contact trip mechanism to be adjusted and to inhibit movement of said slider member in a direction that would actuate said trigger switch.

10. The fastening tool of claim 9 further comprising an adjusting lever connected to said link member wherein said adjusting lever can move said link member to a plurality of positions relative to said slider member.

11. The fastening tool of claim 9 wherein said link member is coupled to said slider member at a lower position relative to said slider member to effectively elongate said contact trip mechanism.

12. The fastening tool of claim 11, wherein said effective elongation of said contact trip mechanism adjusts a depth at which the fastening tool inserts the fastener.

13. The fastening tool of claim 9 wherein said uncoupling of said link member and said slider member includes pivoting said slider member away from said link member.

14. A fastening tool comprising:
a trigger switch having a closed position and an open position, said trigger switch in said closed position executes a driver sequence;
an actuation member movable between a first position and a second position, said first position contacting said trigger switch and moving said trigger switch to said closed position;
a lockout switch connected to said actuation member having a locked-out position and an operational position, said locked-out position holds said actuation member away from said trigger switch.

15. The fastening tool of claim 14 wherein said trigger switch includes a trigger switch body and a trigger switch actuator and wherein trigger switch actuator in said closed position executes a driver sequence.

16. The fastening tool of claim 15 wherein said lockout switch holds said actuation member away from said trigger switch actuator in said lockout position.

17. The fastening tool of claim 14 further comprising a contact trip mechanism having a trigger block, said contact trip mechanism moveable to a retracted position and an extended position.

18. The fastening tool of claim 17 wherein said trigger block is in a blocked position when said contact trip mechanism is in said extended position and said trigger block is in an unblocked position when said contact trip mechanism is in said retracted position.

19. The fastening tool of claim 18 wherein the contact trip mechanism in said retracted position and said lockout switch in said operational position permits said actuation member to contact said trigger switch.

20. A fastening tool comprising:
a trigger;
a trigger switch;
a lockout switch that is operable in a locked-out condition and an operational condition; and
an actuation member, wherein placement of said lockout switch in said operational position permits said actuation member to be moved to actuate said switch in response to retraction of the trigger and wherein placement of said lockout device in the lockout position positions the actuation member out of alignment with at least one of the trigger and the trigger switch so that the actuation member cannot actuate the trigger switch in response to said retraction of the trigger.

21. The fastening tool of claim 20 wherein said trigger switch includes a trigger switch body and a trigger switch actuator and wherein trigger switch actuator in said closed position executes a driver sequence.

22. The fastening tool of claim 21 wherein said lockout switch holds said actuation member away from said trigger switch actuator in said lockout position.

23. The fastening tool of claim 20 further comprising a contact trip mechanism having a trigger block, said contact trip mechanism moveable to a retracted position and an extended position.

24. The fastening tool of claim 23 wherein said trigger block is in a blocked position when said contact trip mechanism is in said extended position and said trigger block is in an unblocked position when said contact trip mechanism is in said retracted position.

25. The fastening tool of claim 24 wherein the contact trip mechanism in said retracted position and said lockout switch in said operational position permits said actuation member to contact said trigger switch.

26. A method of adjusting a depth at which a fastening tool drives a fastener into a work-piece, the method comprising:
providing a contact trip mechanism having a link member and a slider member;
decoupling said link member from said slider member;
holding said contact trip mechanism in an extended position; and
moving said link member relative to said slider member.

27. The method of claim 26 further comprising coupling said link member to said slider member

28. The method of claim 26 wherein said moving said link member relative to said slider member effectively elongates the contact trip mechanism.

29. The method claim 26 wherein said link member relative to said slider member includes pivoting said slider member away from said link member.
